(19) United States
(12) Patent Application Publication
(10) Pub. No.: US 2008/0278096 A1
(43) Pub. Date: Nov. 13, 2008

(54) Configurable Ballast

(75) Inventor: Stuart Berjansky, Crystal Lake, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/092,306

(22) PCT Filed: Oct. 31, 2006
(86) PCT No.: PCT/IB2006/054031

§ 371 Date: May 1, 2008

Related U.S. Application Data
(60) Provisional application No. 60/732,272, filed on Nov. 1, 2005.

(51) Int. Cl. H05B 37/02

(52) U.S. Cl. 315/291

(57) ABSTRACT

A configurable ballast (20) employs a microprocessor (30) and a lead wiring (50) operable to electrically communicate a programming signal (PS) to the microprocessor (30). The programming signal (PS) conveys information to configure a plurality of ballast parameters related to the configurable ballast (20) operating a specific lighting configuration (11) for a specific type of lighting application.

The present invention generally relates to ballasts of any type (e.g., a DALI ballast) for operating lamps of any type (e.g., fluorescent lamps, high discharge lamps and light emitting diode lamps). The present invention specifically relates to a ballast that can be configured either by a manufacturer of the ballast or a customer of the ballast to operate a specific type of lighting configuration (e.g., a specific type and quantity of lamps) for a specific type of lighting application (e.g., a low light output and a high light output).

Multiple versions of a ballast are used to operate the same lamp in different lighting applications, or to operate similar lamps in the same lighting application or in different lighting applications. However, multiple versions of a ballast for the same lamp or similar lamps result in either long delivery lead times for customers when they place an order for a specific type of ballast due to a wait time for a factory to get parts and build the ballast, and/or high inventory costs for maintaining a supply of ballasts and/or ballast parts to build ballasts for multiple types.

The present invention provides a new and unique configurable ballast that can be configured either by a manufacturer of the ballast or a customer of the ballast to operate a specific lighting configuration among a plurality of possible lighting configurations for a specific type of lighting application among a plurality of possible lighting applications.

In a first form of the present invention, a configurable ballast comprises a microprocessor and a lead wiring operable to electrically communicate a programming signal to the microprocessor. The programming signal conveys information to configure one or more ballast parameters related to the configurable ballast operating a specific lighting configuration for a specific type of lighting application.

In a second form of the present invention, a method of configuring the configurable ballast involves a generation of the programming signal conveying the information to configure the ballast parameter(s) related to the configurable ballast operating the specific lighting configuration of lighting for the specific of lighting application, and an imposition of the generated programming signal on the lead wiring to electrically communicate the information to the microprocessor.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

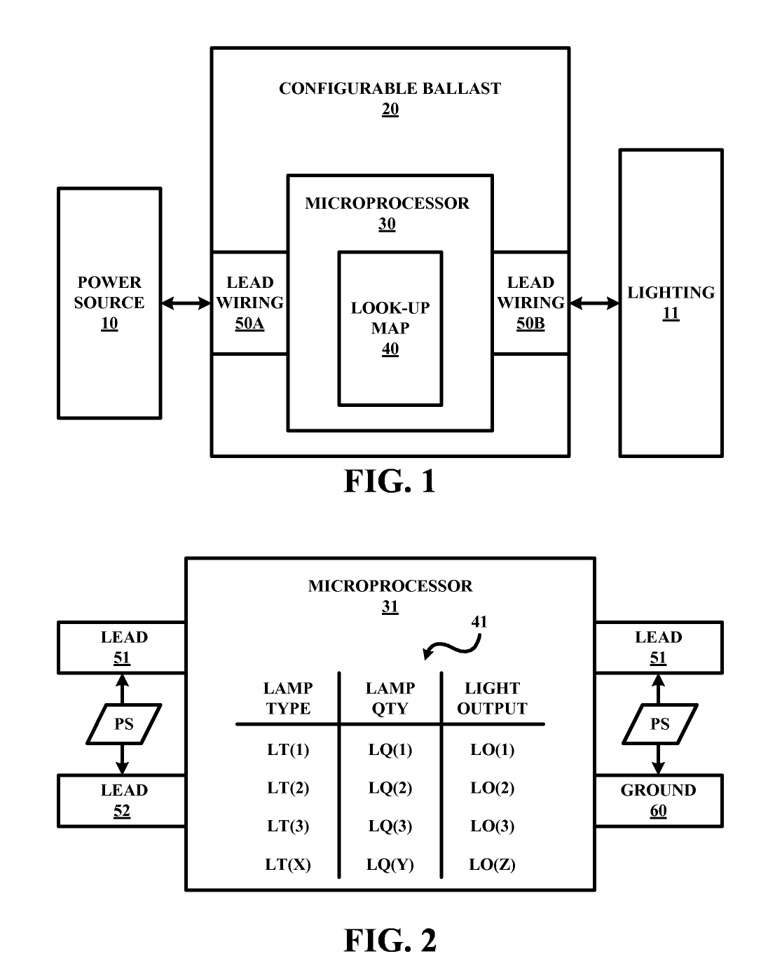

FIG. 1 illustrates a block diagram of one embodiment of a configurable ballast in accordance with the present invention;

FIG. 2 illustrates a block diagram of an exemplary embodiment of the configurable ballast illustrated in FIG. 1 in accordance with the present invention; and

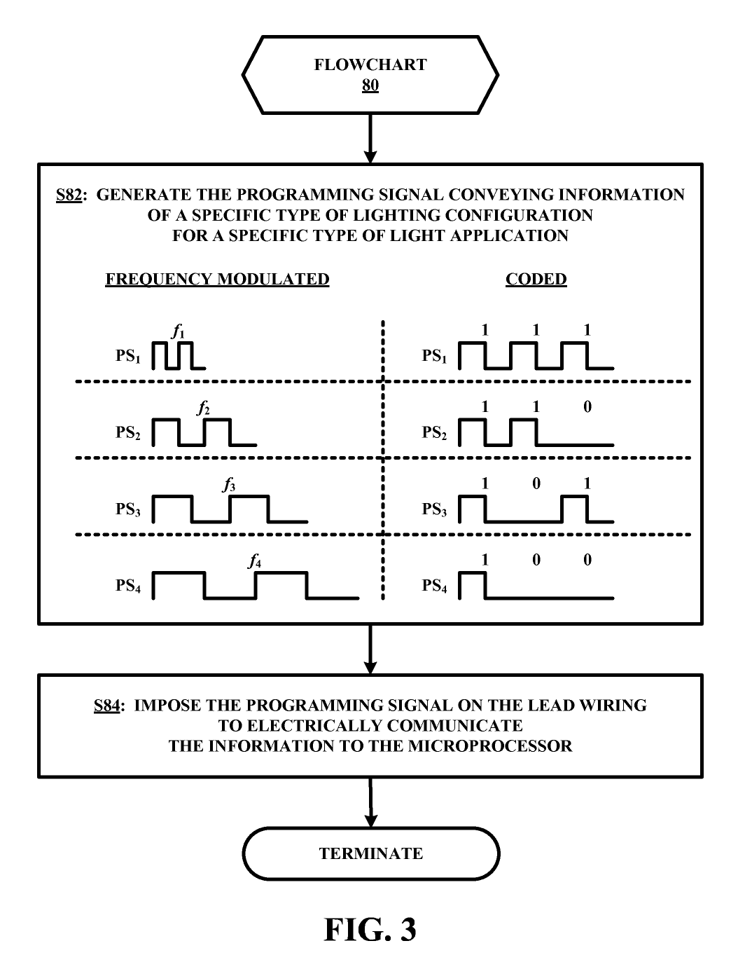

FIG. 3 illustrates a flowchart representative of one embodiment of a ballast configuration method in accordance with the present invention.

A configurable ballast 20 of the present invention as illustrated in FIG. 1 employs a microprocessor 30 and a lead wiring 50. In operation, microprocessor 30 is powered by a power source 10 via lead wiring 50A to control via a lead wiring 50B an operation of a specific type of lighting configuration 11 among a plurality of lighting configurations for a specific type of lighting application among a plurality of lighting applications. To this end, microprocessor 30 includes a look-up map 40 mapping the plurality of lighting configurations and the plurality of lighting applications based on one or more ballast parameters, and lead wiring 50 is additionally used to electrically communicate a programming signal conveying information to configure the ballast parameter(s) to thereby pre-configure ballast 20 for operating lighting configuration 11 for a specific type of lighting application. In an alternative embodiment, look-up map 40 can be programmed within another component of ballast 20 and accessible by microprocessor 30

The present invention does not impose any limitations or any restrictions to the structural configurations of microprocessor 30 and lead wiring 50. Thus, the following description of an exemplary embodiment of microprocessor 30 and lead wiring 50 as illustrated in FIG. 2 does not limit nor restrict the scope of structural configurations of microprocessor 30 and lead wiring 50 in accordance with the present invention.

FIG. 2 illustrates an embodiment 31 of microprocessor 30 (FIG. 1) having a look-up map 41 mapping a plurality of lighting configurations and a plurality of lighting applications based ballast parameters in the form of a lamp type and a lamp quantity for identifying the lighting configurations and in the form of a light output for identifying the lighting applications. In one embodiment, the light output parameter includes sub-ballast parameters in the form of a lamp voltage, a lamp current, a filament power (for fluorescent lamps) and a run-up current (for HID lamps).

In operation, a programming signal PS can be imposed between a lead 51 (e.g., a black color coded “hot” lead) and a lead 52 (e.g., a white color coded “common” lead) to thereby electrically communicate information conveying information to configure the ballast parameters of look-up map 41. Alternatively, programming signal PS is imposed between lead 51 and a ground connection 60 to thereby electrically communicate information conveying information to configure the ballast parameters of look-up map 41.

FIG. 3 illustrates a flowchart 80 representative of a ballast configuration method of the present invention for performing multiple configurations of configurable ballast 20 (FIG. 1).

An initial execution of a stage S82 of flowchart 80 encompasses a generation of a programming signal conveying a first information of a first type of lighting configuration for a first type of lighting application (e.g., a fluorescent lamp configuration for a low power light output). In one embodiment, the programming signal is generated as a programming signal PS_{ƒ1} at a frequency ƒ₁ indicative of the first information. In an alternative embodiment, the programming signal is generated as a programming signal PS_{C1} with a “111” coding indicative of the first information.

An initial execution of a stage S84 of flowchart 80 encompasses an imposition of the programming signal as programming signal PS_{ƒ1} or programming signal PS_{C1} as on lead wiring 50 to electrically communicate the first information to microprocessor 30 to thereby configure the ballast parameters of look-up map 40 as needed.

A subsequent execution of stage S82 of flowchart 80 encompasses a regeneration of the programming signal to convey a second information either of the first type of lighting configuration for a second type of lighting application (e.g., the fluorescent lamp configuration for a high light output), a second type of lighting configuration for the first type of lighting application (e.g., a HID lamp configuration for a low light output), or the second type of lighting configuration for the second type of lighting application (e.g., a HID lamp configuration for a high light output). In one embodiment, the programming signal is modulated as (1) a programming signal PS_{ƒ2} at a frequency ƒ₂ indicative of the second information of the first type of lighting configuration for a second type of lighting application, (2) programming signal PS_{ƒ3} at a frequency ƒ₃ indicative of the second information of the second type of lighting configuration for the first type of lighting application, or (3) a programming signal PS_{ƒ4} at a frequency ƒ₄ indicative of the second information of the second type of lighting configuration for the second type of lighting application. In an alternative embodiment, the programming signal is modulated as (1) a programming signal PS_{C2} with a “110” coding indicative of the second information of the first type of lighting configuration for a second type of lighting application, (2) programming signal PS_{C3} with a “101” coding indicative of the second information of the second type of lighting configuration for the first type of lighting application, or (3) a programming signal PS_{C3} with a “100” coding indicative of the second information of the second type of lighting configuration for the second type of lighting application.

A subsequent execution of stage S84 of flowchart 80 encompasses an imposition of the programming signal as programming signal PS_{ƒ2}, programming signal PS_{ƒ3}, programming signal PS_{ƒ4}, programming signal PS_{C2}, programming signal PS_{C3} or programming signal PS_{C4} on lead wiring 50 to electrically communicate the second information to microprocessor 30 to thereby configure the ballast parameters of look-up map 40 as needed.

The frequency modulation and coding of the programming signal as illustrated in FIG. 3 corresponds to a minimal complexity programming scenario of the present invention to facilitate an understanding of the present invention. From the teachings of FIG. 3, those having ordinary skill in the art will appreciate how to make and use the present invention for more complex programming scenarios.

Referring to FIG. 1, additional ballast components as known in the art were omitted from configurable ballast 20 shown FIG. 1 for purposes of facilitating an understanding of the present invention. Nonetheless, those having ordinary skill in the art will appreciate how to make and use these additional ballast components in view of the various inventive principles of the present invention.

Referring to FIGS. 1-3, those having ordinary skill in the art will appreciate numerous advantages of the present invention including, but not limited to, providing a configurable ballast that can be configured either by a manufacturer of the ballast or a customer of the ballast to operate a specific type of lighting configuration for a specific type of lighting application.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

1. A configurable ballast comprising:
a microprocessor; and
a lead wiring operable to electrically communicate a programming signal to the microprocessor, wherein the programming signal conveys information to configure at least one ballast parameter related to the configurable ballast operating a specific lighting configuration for a specific type of lighting application.

2. The configurable ballast of claim 1, wherein the programming signal is imposed at least between a first lead and a second lead of the lead wiring.

3. The configurable ballast of claim 1, wherein the programming signal is imposed at least between a lead of the lead wiring and a ground connections.

4. The configurable ballast of claim 1, wherein the programming signal is modulated to distinguish a first information for a first lighting configuration and a first lighting application from a second information for a second lighting configuration and the first lighting application.

5. The configurable ballast claim 1, wherein the programming signal is modulated to distinguish a first information for a first lighting configuration and a first lighting application from a second information for the first lighting configuration and a second lighting application.

6. The configurable ballast of claim 1, wherein the programming signal is modulated to distinguish a first information for a first lighting configuration and a first lighting application from a second information for a second lighting configuration and a second lighting application.
